(19) United States
(12) Patent Application Publication
(10) Pub. No.: US 2026/0135335 A1
(43) Pub. Date: May 14, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Akihiro NISHITANI, Mie (JP)

(21) Appl. No.: 18/705,187

(22) PCT Filed: Oct. 19, 2022
(86) PCT No.: PCT/JP2022/038935

§ 371 Date: Apr. 26, 2024

(30) Foreign Application Priority Data
Nov. 8, 2021 (JP) 2021-181776

(51) Int. Cl. H01R 13/641

(52) U.S. Cl. CPC H01R 13/641

(57) ABSTRACT

A connector includes a terminal, a housing for accommodating the terminal inside, and a formwork portion provided on the housing to be visually confirmable from outside. The formwork portion includes a body portion and recesses recessed from the body portion in an intersecting direction intersecting a connection direction of the connector and a mating connector. The connector or the mating connector includes a background portion to be arranged more inward than the formwork portion in the housing. With connection of the connector and the mating connector completed, the background portion is disposed at a completion position and the formwork portion and the background portion overlap in the intersecting direction, whereby a color difference is produced between inner parts of the recesses and the body portion to make a code detectable from outside appear. The code does not appear without the background portion being disposed at the completion position.

### TECHNICAL FIELD

The present disclosure relates to a connector.

### BACKGROUND

Conventionally, an electrical connector described in Japanese Patent Laid-Open Publication No. 2018-535524 (Patent Document 1 below) is known as a connector provided with a connection detecting function of detecting whether or not a male housing and a female housing have been properly connected. This electrical connector includes a first connector and a second connector, and the first connector is provided with a housing, a plurality of conductors held by the housing and a lever rotatably coupled to the housing. The lever is rotatable between an open position and a closed position with respect to the housing.

A barcode label is arranged on the outer surface of a left side wall of the housing. When the lever is at the open position, the barcode label is hidden by the lever and cannot be read by a barcode scanner. On the other hand, when the lever is at the closed position, the barcode label is exposed through a recessed part provided in the lever, whereby the barcode label can be read by the barcode scanner.

If the barcode label is read by the barcode scanner, it can be recorded that the first and second connectors are connected, and a progress of a manufacturing or assembly process can be traced.

### Prior Art Document

### Patent Document

Patent Document 1: JP 2018-535524 A

### SUMMARY OF THE INVENTION

### Problems to be Solved

However, in the above electrical connector, since the barcode label is hidden by the lever when the lever is at the open position, the position of the barcode label cannot be known. Therefore, depending on the position of the barcode label, it may not be possible to immediately find the barcode label after the lever is rotated from the open position to the closed position.

### Means to Solve the Problem

The present disclosure is directed to a connector to be connected to a mating connector, the connector being provided with a terminal, a housing for accommodating the terminal inside and a formwork portion provided on the housing to be visually confirmable from outside, the formwork portion including a body portion and recesses recessed from the body portion in an intersecting direction intersecting a connection direction of the connector and the mating connector, the connector or the mating connector including a background portion to be arranged more inward than the formwork portion in the housing, the background portion being disposed at a completion position and the formwork portion and the background portion overlapping in the intersecting direction, whereby a color difference is produced between inner parts of the recesses and the body portion to make a code detectable from outside appear, with connection of the connector and the mating connector completed, and the code not appearing without the background portion being disposed at the completion position.

### Effect of the Invention

According to the present disclosure, a code can be immediately found with the connection of a connector and a mating connector completed.

### BRIEF DESCRIPTION OF THE DRAWINGS

FIG. 1 is a perspective view of a connector assembly according to a first embodiment.

FIG. 2 is an exploded perspective view showing the connector assembly.

FIG. 3 is an exploded perspective view showing a female connector.

FIG. 4 is a plan view of the female connector with a female retainer mounted at a locking position.

FIG. 5 is a left side view of the female connector with the female retainer mounted at a retracted position.

FIG. 6 is a section along A-A of FIG. 4 of the female connector with the female retainer mounted at the retracted position.

FIG. 7 is a section along B-B of FIG. 4 of the female connector with the female retainer mounted at the retracted position.

FIG. 8 is a left side view of the female connector with the female retainer mounted at the locking position.

FIG. 9 is a section along A-A of FIG. 4.

FIG. 10 is a section along B-B of FIG. 4.

FIG. 11 is a section along C-C of FIG. 4.

FIG. 12 is a section along A-A of FIG. 4 of a male connector and the female connector being connected.

FIG. 13 is a section along B-B of FIG. 4 of the male connector and the female connector being connected.

FIG. 14 is a section along C-C of FIG. 4 of the male connector and the female connector being connected.

FIG. 15 is an enlarged left side view of the male connector and the female connector in a connection completed state enlargedly showing around a code.

FIG. 16 is a section along A-A of FIG. 4 of the male connector and the female connector in the connection completed state.

FIG. 17 is a section along C-C of FIG. 4 of the male connector and the female connector in the connection completed state.

FIG. 18 is a section along D-D of FIG. 15.

FIG. 19 is a section along D-D of FIG. 15 of the female connector with the female retainer mounted at the locking position.

FIG. 20 is an enlarged left side view of a male connector and a female connector in a connection completed state according to a second embodiment enlargedly showing around a code.

FIG. 21 is a section along E-E of FIG. 20.

### DETAILED DESCRIPTION TO EXECUTE THE INVENTION

### Description of Embodiments of Present Disclosure

First, embodiments of the present disclosure are listed and described.

(1) The connector of the present disclosure is to be connected to a mating connector and provided with a terminal, a housing for accommodating the terminal inside and a formwork portion provided on the housing to be visually confirmable from outside, the formwork portion including a body portion and recesses recessed from the body portion in an intersecting direction intersecting a connection direction of the connector and the mating connector, the connector or the mating connector including a background portion to be arranged more inward than the formwork portion in the housing, the background portion being disposed at a completion position and the formwork portion and the background portion overlapping in the intersecting direction, whereby a color difference is produced between inner parts of the recesses and the body portion to make a code detectable from outside to appear, with connection of the connector and the mating connector completed, and the code not appearing without the background portion being disposed at the completion position.

According to this configuration, the formwork portion of the connector is provided to be visually confirmable from outside, and the formwork portion and the background portion overlap to make the code detectable from outside appear with the connection of the connector and the mating connector completed. Thus, a worker can recognize the appearance position of the code by the formwork portion before connecting the connector and the mating connector.

(2) Preferably, the connector of the present disclosure is further provided with a retainer for retaining the terminal in the housing, and the retainer includes the background portion.

According to this configuration, the code can be made to appear by the formwork portion of the housing and the background portion of the retainer.

(3) Preferably, the recesses are through holes penetrating through the body portion.

According to this configuration, since the background portion is exposed to outside through the through holes, a color difference is easily produced between the background portion and the body portion.

(4) Preferably, thin portions thinner than the body portion are provided in the recesses.

According to this configuration, the recesses are easily formed.

### Details of Embodiments of Present Disclosure

Hereinafter, embodiments of the present disclosure are described. The present disclosure is not limited to these illustrations, but is represented by claims and intended to include all changes in the scope of claims and in the meaning and scope of equivalents.

### First Embodiment

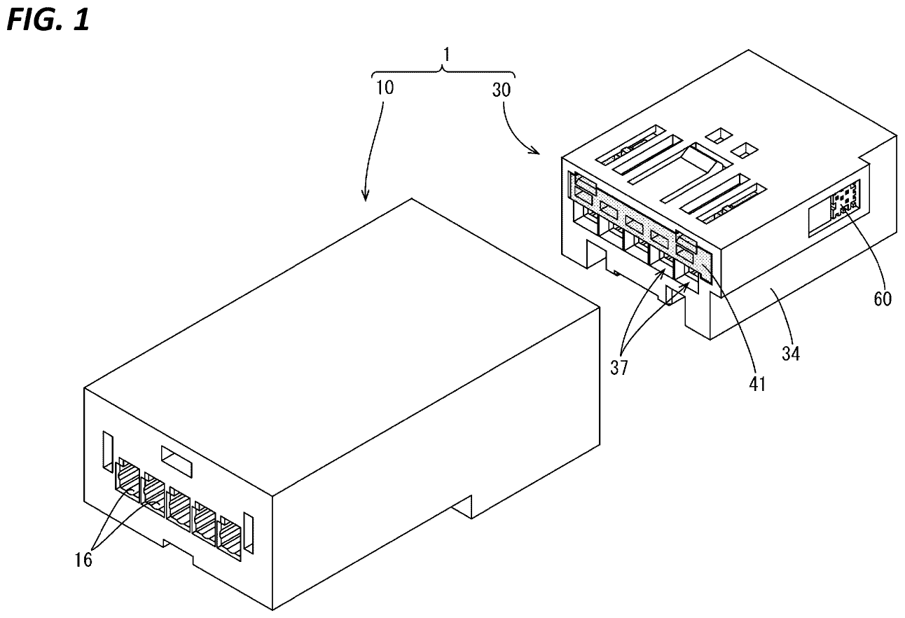

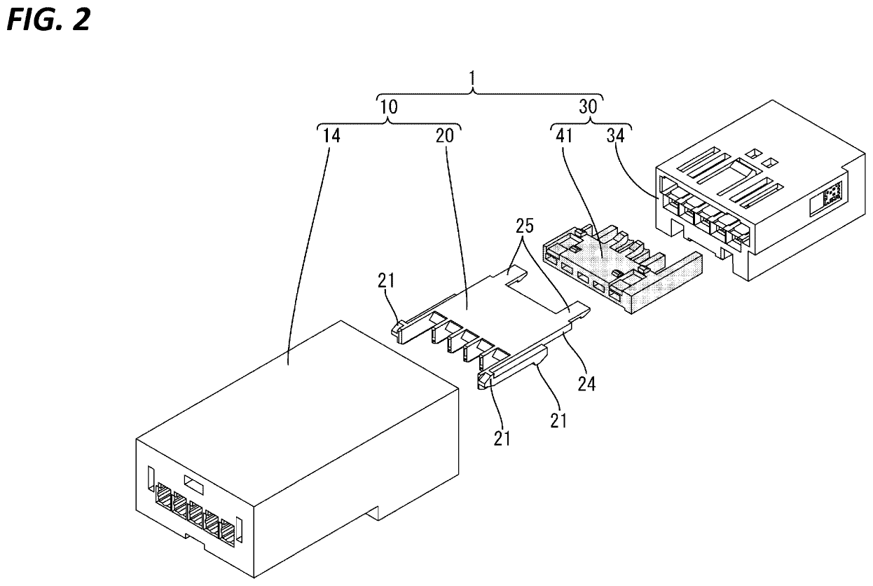

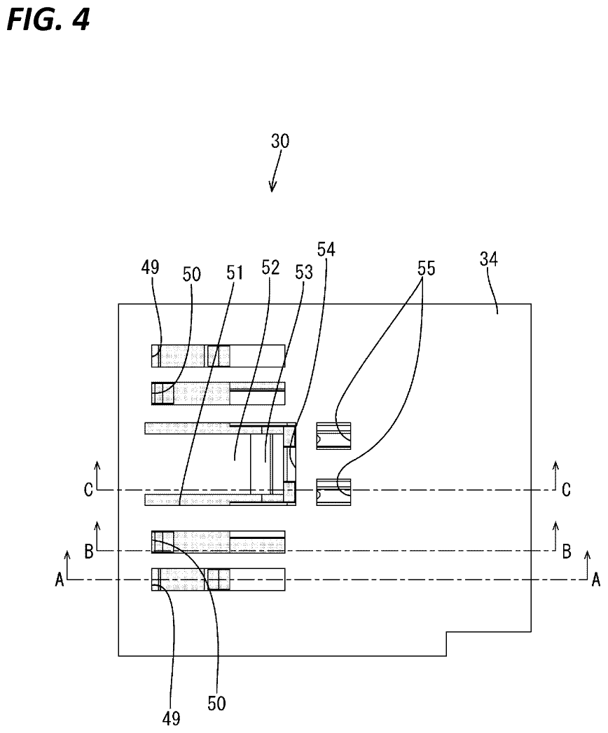

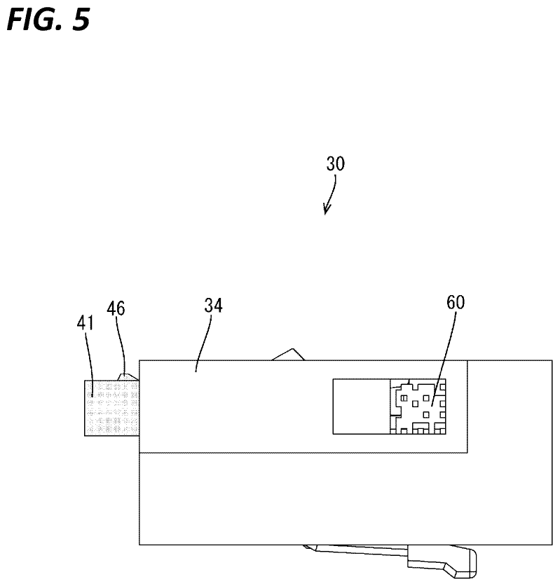

A first embodiment of the present disclosure is described with reference to FIGS. 1 to 19. As shown in FIGS. 1 and 2, a connector assembly 1 according to this embodiment includes a female connector 30 (an example of a connector) and a male connector 10 (an example of a mating connector). In the following description, a front-rear direction is based on a connection direction of the male connector 10 and the female connector 30, and connection surface sides of those connectors are referred to as front sides. A vertical direction is based on FIG. 5. Upper and lower sides in a plan view of FIG. 4 are referred to as right and left sides concerning a lateral direction. In this embodiment, the front-rear direction is an example of the connection direction and the lateral direction is an example of an intersecting direction. Note that, for a plurality of identical members, only some members may be denoted by a reference sign and the others may not be denoted by the reference sign.

### Male Connector

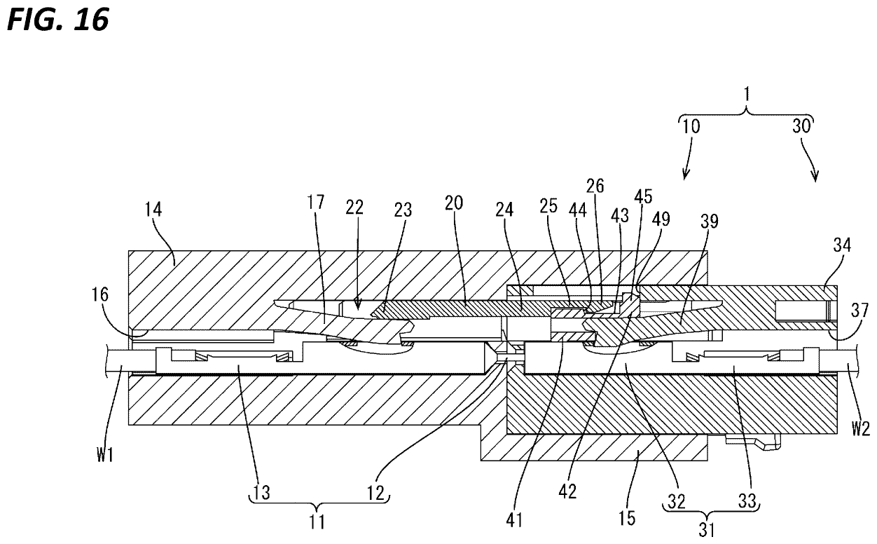

As shown in FIG. 16, the male connector 10 is provided with male terminals 11, a male housing 14 for accommodating the male terminals 11 and a male retainer 20 to be mounted into the male housing 14.

The male terminal 11 is formed by press-working a metal plate material into a predetermined shape. The male terminal 11 includes a plate-like tab 12 projecting forward and a wire connecting portion 13 connected behind the tab 12 and to be connected to a wire W1. By crimping the wire connecting portion 13 to the outer periphery of the wire W1, the wire W1 and the wire connecting portion 13 are electrically connected.

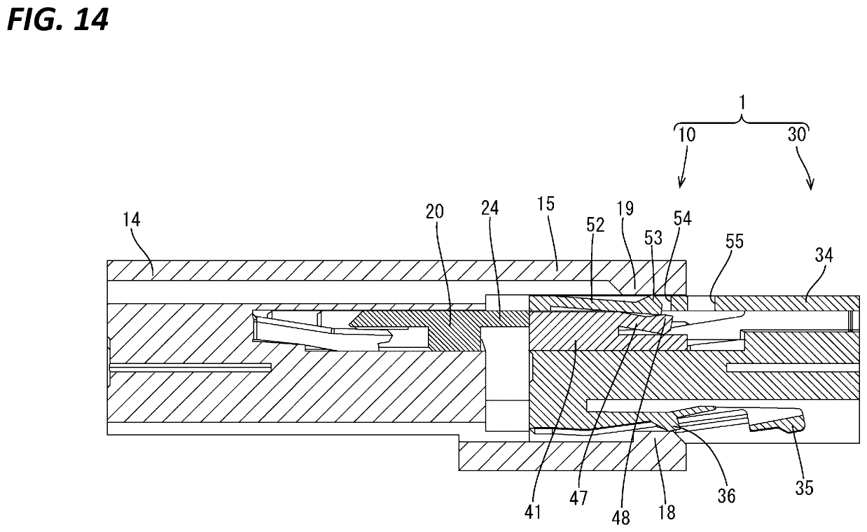

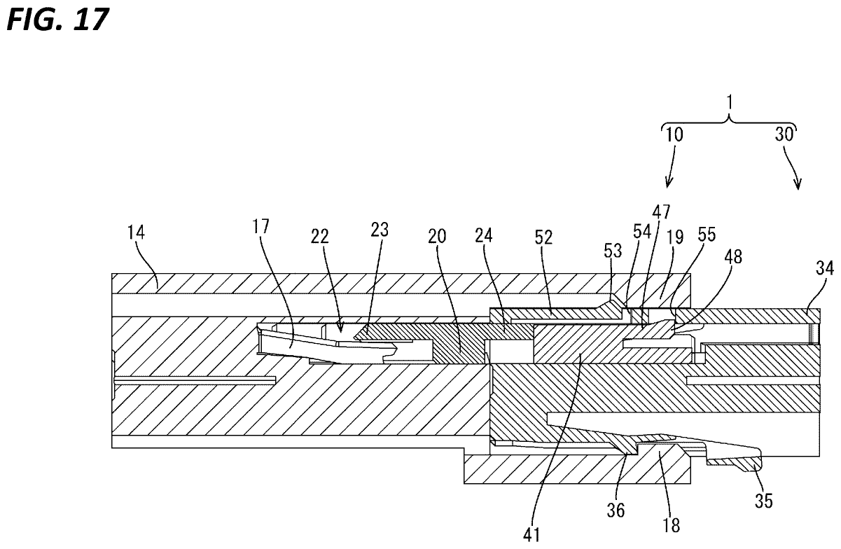

The male housing 14 has a rectangular parallelepiped shape as a whole and is made of insulating synthetic resin. The male housing 14 includes a receptacle 15 open forward. The tabs 12 of the male terminals 11 are disposed to project forward in the receptacle 15. As shown in FIG. 1, a plurality of (five in this embodiment) male cavities 16 for accommodating the male terminals 11 are formed at intervals in the lateral direction in the male housing 14. As shown in FIG. 16, a male locking lance 17 extending to project forward and resiliently deformable is formed inside the male cavity 16. A front end part of the male locking lance 17 locks the male terminal 11 from behind, whereby the male terminal 11 is held retained in the male cavity 16. As shown in FIG. 17, a lock receiving portion 18, into which a lock portion 36 of a lock arm 35 to be described later is fit, is provided to penetrate through the lower wall of the receptacle 15. As shown in FIG. 14, a pressing projection 19 for pressing a female retainer 41 to be described later from above is provided to project downward on the upper wall of the receptacle 15.

As shown in FIG. 2, the male retainer 20 is in the form of a vertically flat plate as a whole and made of insulating synthetic resin. Lock portions 21 to be resiliently locked to the male housing 14 are provided on both left and right end parts of the male retainer 20. Although not shown, the male retainer 20 is fixed to the male housing 14 by locking the lock portions 21 to the male housing 14.

As shown in FIG. 16, the male retainer 20 includes a restricting portion 23 for preventing the male locking lances 17 from being resiliently deformed by entering a resilient deformation space 22, into which the male locking lances 17 of the male housing 14 are resiliently deformed, from front. The restricting portion 23 is formed to project rearward from a rear end part of the male retainer 20 at a position corresponding to the male locking lances 17 of the male housing 14.

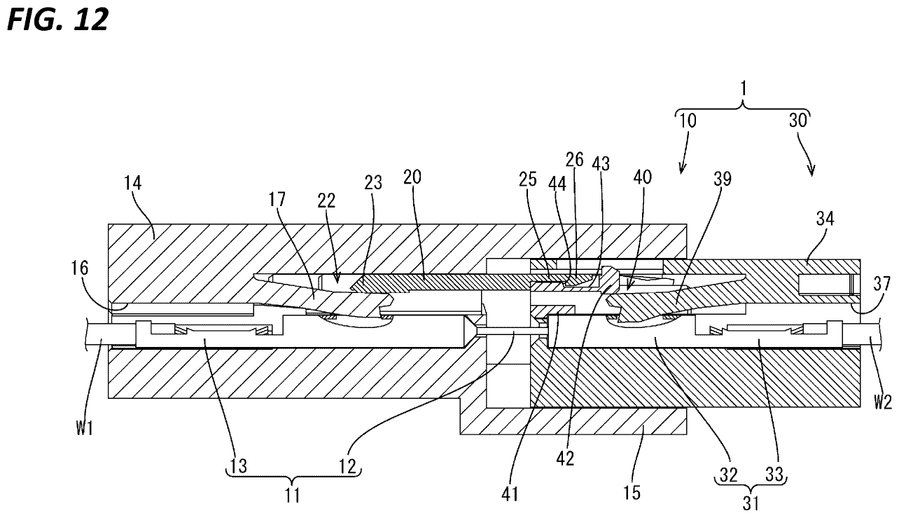

As shown in FIG. 17, a contact portion 24 projecting forward and configured to come into contact with the female retainer 41 to be described later is formed on a front upper end part of the male retainer 20. As shown in FIG. 2, the contact portion 24 is in the form of a vertically flat plate. Arm portions 25 projecting from both left and right end parts are formed on a front end part of the contact portion 24. The arm portion 25 is elongated in the front-rear direction. As shown in FIG. 12, a locking portion 26 projecting downward is formed on a front end part of the arm portion 25. The locking portion 26 is locked to a lock receiving portion 44 of the male retainer 41 to be described later. The rear end surface of the locking portion 26 is formed to steeply extend from the lower surface of the arm portion 25. On the other hand, the front end surface of the locking portion 26 is formed to be gently inclined with respect to the front-rear direction.

### Female Connector

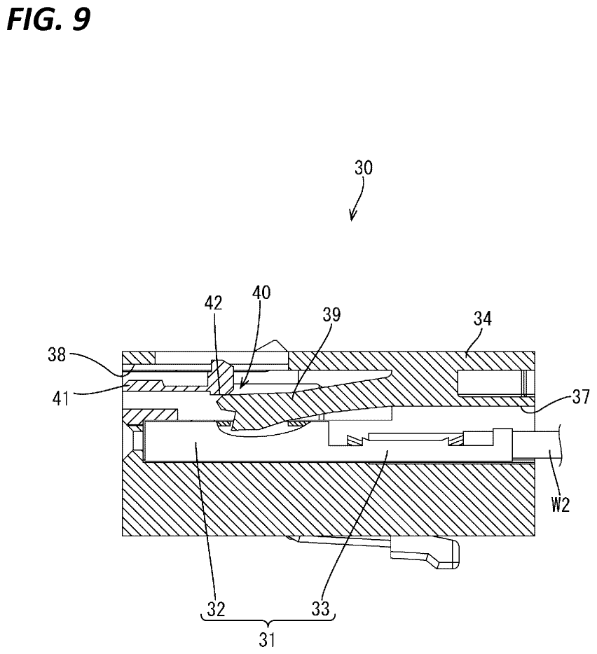

As shown in FIG. 9, the female connector 30 is provided with female terminals 31 (an example of a terminal), a female housing 34 (an example of a housing) for accommodating the female terminals 31 inside, and the female retainer 41 (an example of a retainer) to be mounted into the female housing 34 from front.

The female terminal 31 is formed by press-working a metal plate material into a predetermined shape. The female terminal 31 includes a connecting tube portion 32 and a wire connecting portion 33 connected behind the connecting tube portion 32 and to be connected to a wire W2. As shown in FIG. 16, if the tab 12 is inserted into the connecting tube portion 32, a resilient contact piece (not shown) disposed in the connecting tube portion 32 and the tab 12 resiliently contact. In this way, the male terminal 11 and the female terminal 31 are electrically connected. Further, by crimping the wire connecting portion 33 to the outer periphery of the wire W2, the wire W2 and the wire connecting portion 33 are electrically connected.

As shown in FIG. 2, the female housing 34 has a rectangular parallelepiped shape as a whole. The female housing 34 is made of insulating synthetic resin. As shown in FIG. 17, the lock arm 35 extending rearward from a front end part is formed on the lower surface of the female housing 34. The lock arm 35 is resiliently deformable in the vertical direction. The lock portion 36 projecting downward is formed near a center position in the front-rear direction of the lock arm 35.

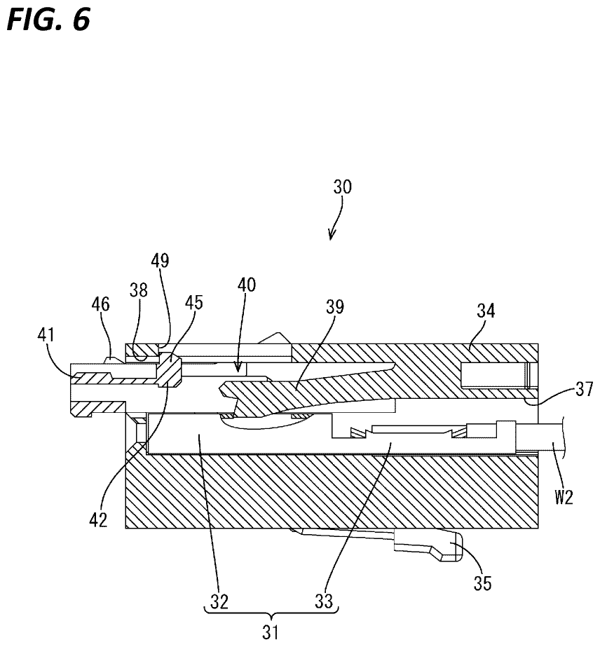

As shown in FIG. 1, the female housing 34 includes a plurality of (five in this embodiment) female cavities 37 open forward and rearward. The female cavities 37 are formed side by side at intervals in the lateral direction near a center position of the female housing 34 in the vertical direction. As shown in FIG. 6, the female terminal 31 is accommodated into the female cavity 37 from behind.

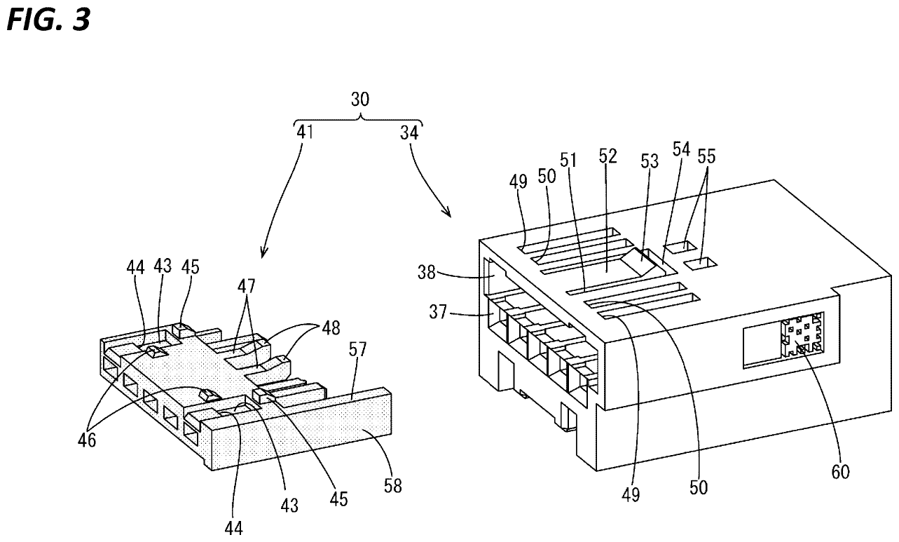

As shown in FIG. 3, a retainer accommodating portion 38 for accommodating the female retainer 41 is formed to be open forward at a position above the female cavities 37 in a front end part of the female housing 34. The retainer accommodating portion 38 is elongated in the lateral direction and formed to have a flat shape in the vertical direction. The retainer accommodating portion 38 and the female cavities 37 communicate in the vertical direction.

As shown in FIG. 6, female locking lances 39 cantilevered obliquely to a front lower side are formed at positions corresponding to the respective female cavities 37 on the upper wall of the retainer accommodating portion 38. The female locking lance 39 is resiliently displaceable toward a resilient deformation space 40 provided above the female locking lance 39. If the female terminal 31 is inserted to a proper insertion position of the female cavity 37, the female locking lance 39 and the female terminal 31 are locked in the front-rear direction, whereby the female terminal 31 is held in the female housing 34 while being prevented from coming out rearward. The resilient deformation space 40 for the female locking lances 39 is set in the retainer accommodating portion 38.

As shown in FIG. 3, the female retainer 41 is in the form of a vertically flat plate as a whole. The female retainer 41 is made of insulating synthetic resin.

As shown in FIG. 9, a part of the female retainer 41 near a rear end part of an upper wall serves as a restricting portion 42 for preventing the female locking lances 39 from being resiliently deformed by entering the resilient deformation space 40 for the female locking lances 39 with the female terminals 31 locked by the female locking lances 39.

As shown in FIG. 3, locking recesses 43 recessed downward are respectively formed at positions near both left and right end parts of the upper surface of the upper wall of the female retainer 41. The locking recess 43 is formed to be elongated in the front-rear direction. Two locking recesses 43 are formed to have the same shape and size. Note that the same shape and size mean not only a case of being the same shape and size, but also a case of not being the same shape and size, but being recognizable as substantially the same shape and size.

The locking recess 43 is formed to be depressed in two stages in the front-rear direction such that a rear side is deeper. In other words, a depression depth of the locking recess 43 from the upper surface of the female retainer 41 is larger in a rear part than in a front part. In this way, the locking recess 43 is formed with the step-like lock receiving portion 44 between the front and rear parts. As shown in FIG. 12, the lock receiving portion 44 is locked to the locking portion 26 of the male retainer 20.

As shown in FIG. 3, first locking portions 45 projecting upward are formed at positions behind the locking recesses 43 on the upper surface of the female retainer 41. The front end surface of the first locking portion 45 is formed to extend steeply upward from the upper surface of the female retainer 41. The rear end surface of the first locking portion 45 is formed to be gently inclined with respect to the front-rear direction. Two first locking portions 45 are formed to have same shape and size.

Second locking portions 46 projecting upward are respectively formed at positions inward of the locking recesses 43 in the lateral direction on the upper surface of the female retainer 41. In other words, the second locking portions 46 are respectively formed at a position to the right of the locking recess 43 formed on a left side and a position to the left of the locking recess 43 formed on a right side. The front end surface of the second locking portion 46 is formed to extend steeply upward from the upper surface of the female retainer 41. An angle of inclination of the front end surface of the second locking portion 46 from the upper surface of the female retainer 41 is gentler than that of the front end surface of the first locking portion 45. The rear end surface of the second locking portion 46 is formed to be gently inclined with respect to the front-rear direction. Two second locking portions 46 are formed to have same shape and size.

Two arm portions 47 projecting rearward from the vicinity of a center position in the lateral direction are formed in a rear end part of the female retainer 41. The two arm portions 47 are formed to have the same shape and size. A third locking portion 48 projecting upward is formed on a rear end part of the arm portion 47. The front end surface of the third locking portion 48 is formed to be gently inclined with respect to the front-rear direction. The rear end surface of the third locking portion 48 is formed to be orthogonal to the upper surface of the female retainer 41. Note that orthogonal means not only a case of being orthogonal, but also a case of not being orthogonal, but being recognizable as substantially orthogonal.

As shown in FIG. 6, the upper wall of the female housing 34 is formed with first lock receiving portions 49 extending in the front-rear direction and penetrating through the upper wall in the vertical direction at positions corresponding to the first locking portions 45 with the female retainer 41 accommodated in the retainer accommodating portion 38. As shown in FIG. 4, the first lock receiving portions 49 are formed at positions near both left and right end parts of the upper wall of the female housing 34. The first locking portion 49 has a rectangular shape when viewed from above. Two first lock receiving portions 49 are formed to have the same shape and size.

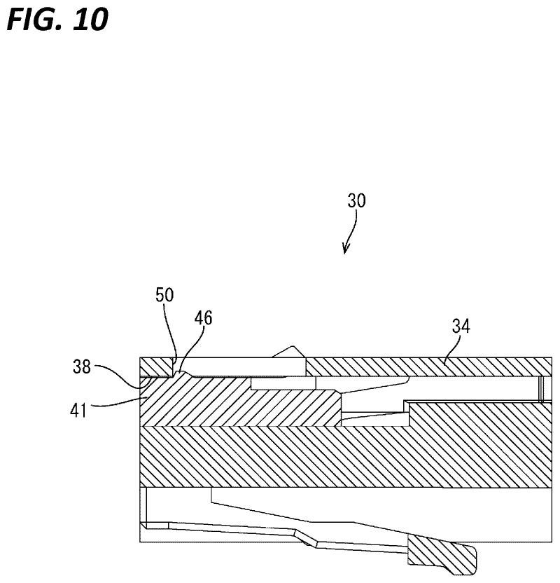

As shown in FIG. 10, the upper wall of the female housing 34 is formed with second lock receiving portions 50 extending in the front-rear direction and penetrating through the upper wall in the vertical direction at positions corresponding to the second locking portions 46 with the female retainer 41 accommodated in the retainer accommodating portion 38. As shown in FIG. 4, the second lock receiving portions 50 are formed inwardly of the first lock receiving portions 49 in the lateral direction in the upper wall of the female housing 34. In other words, the second lock receiving portion 50 is formed to the right of the first lock receiving portion 49 formed on a left side of the upper wall of the female housing 34, and the second lock receiving portion 50 is formed to the left of the first lock receiving portion 49 formed on a right side. The second locking portion 50 has a rectangular shape when viewed from above. Two second lock receiving portions 50 are formed to have the same shape and size.

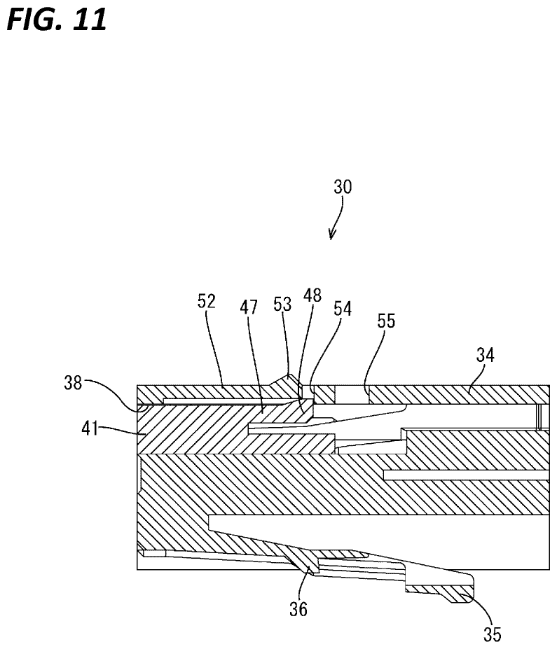

As shown in FIG. 4, the upper wall of the female housing 34 is formed with an angular C-shaped slit 51 near a center in the lateral direction when viewed from above. The slit 51 includes two parts arranged at an interval in the lateral direction and extending in the front-rear direction and a part coupling rear end parts of these two parts. A resilient deforming portion 52 extending in the front-rear direction is formed in a region surrounded by this slit 51. As shown in FIG. 11, the resilient deforming portion 52 is formed above the arm portions 47 of the female retainer 41 with the female retainer 41 accommodated in the retainer accommodating portion 38. A projection 53 projecting upward is formed on a rear end part of the resilient deforming portion 52. The front and rear end surfaces of the projection 53 are formed to be gently inclined with respect to the front-rear direction.

The part extending in the lateral direction and located behind the resilient deforming portion 52, out of the slit 51, serves as a front third lock receiving portion 54 lockable to the third locking portions 48 of the female retainer 41. Further, as shown in FIG. 4, the upper wall of the female housing 34 is formed with two rear third lock receiving portions 55 arranged at an interval in the lateral direction and penetrating through the upper wall in the vertical direction at positions behind the third lock receiving portion 54. The rear third lock receiving portion 55 has a rectangular shape when viewed from above. As shown in FIG. 17, the rear third lock receiving portions 55 are lockable to the third locking portions 48 of the female retainer 41.

### Assembly Structure of Female Housing and Female Retainer

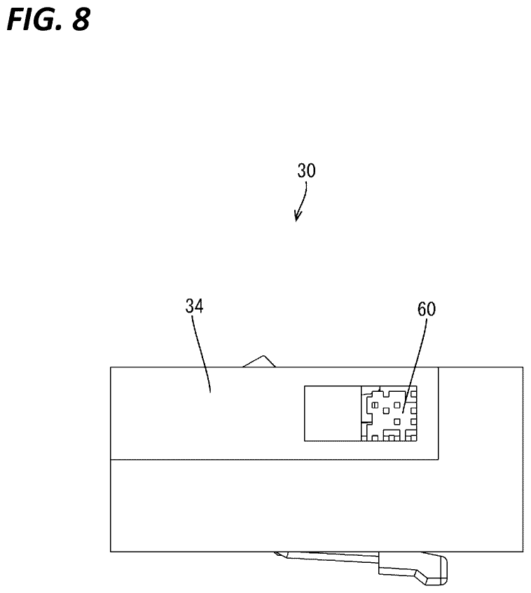

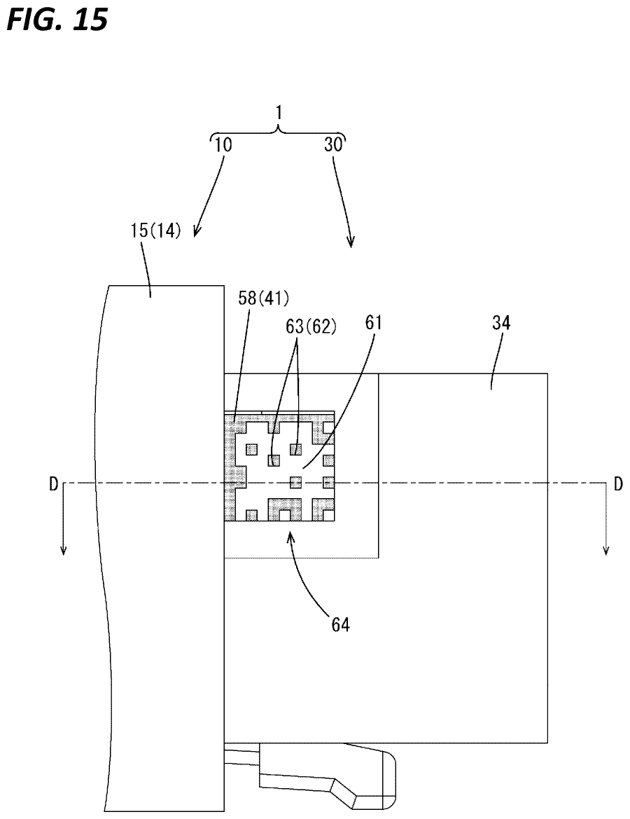

The female retainer 41 is mounted into the female housing 34 movably between a retracted position (see FIGS. 5 to 7), a locking position (see FIGS. 8 to 11) behind the retracted position and a completion position (see FIGS. 15 to 17) behind the locking position.

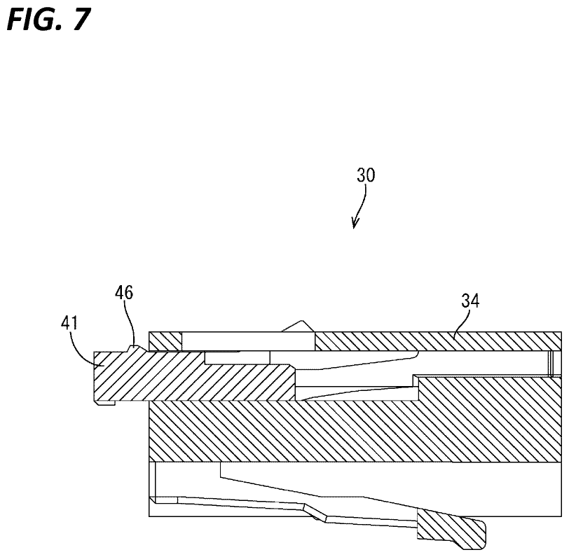

As shown in FIG. 6, with the female retainer 41 assembled with the female housing 34 at the retracted position, the front end surfaces of the first locking portions 45 are in contact with the front walls of the first lock receiving portions 49 from behind. In this way, the female retainer 41 is held in the female housing 34 while being prevented from coming out forward. As shown in FIG. 7, the rear end surfaces of the second locking portions 46 are in contact with the front surface of the female housing 34 from front. In this way, the female retainer 41 is held in the female housing 34 with a rearward movement restricted. As shown in FIG. 6, the restricting portion 42 is retracted in front of the resilient deformation space 40. In this way, the female locking lances 39 are resiliently deformable into the resilient deformation space 40.

As shown in FIG. 10, the second locking portions 46 are in contact with the front walls of the second lock receiving portions 50 from behind with the female retainer 41 assembled with the female housing 34 at the locking position. In this way, the female retainer 41 is held in the female housing 34 while being prevented from coming out forward. As shown in FIG. 11, the third locking portions 48 are in contact with the rear wall of the front third lock receiving portion 54 from front. In this way, the female retainer 41 is held in the female housing 34 with a rearward movement restricted. As shown in FIG. 9, the restricting portion 42 is located in the resilient deformation space 40. In this way, the female locking lances 39 are prevented from being resiliently deformed.

As shown in FIG. 17 the contact portion 24 of the male retainer 20 is in contact with the front end surface of the female retainer 41 with the female retainer 41 assembled with the female housing 34 at the completion position. In this way, a forward movement of the female retainer 41 is restricted. The third locking portions 48 are in contact with the rear walls of the rear third lock receiving portions 55 from front. In this way, the female retainer 41 is held in the female housing 34 with a rearward movement restricted.

### Background Portion

As shown in FIG. 3, a projecting portion 57 projecting rearward from a left part is formed in a rear end part of the female retainer 41. The projecting portion 57 has a rectangular parallelepiped shape long in the front-rear direction. The left side surface of the projecting portion 57 is formed to be orthogonal to the upper surface of the female retainer 41. A rear part of the left side surface of the projecting portion 57 serves as a background portion 58. The background portion 58 causes a code 64 to appear (see FIG. 15) by overlapping a formwork portion 60 to be described later.

### Formwork Portion

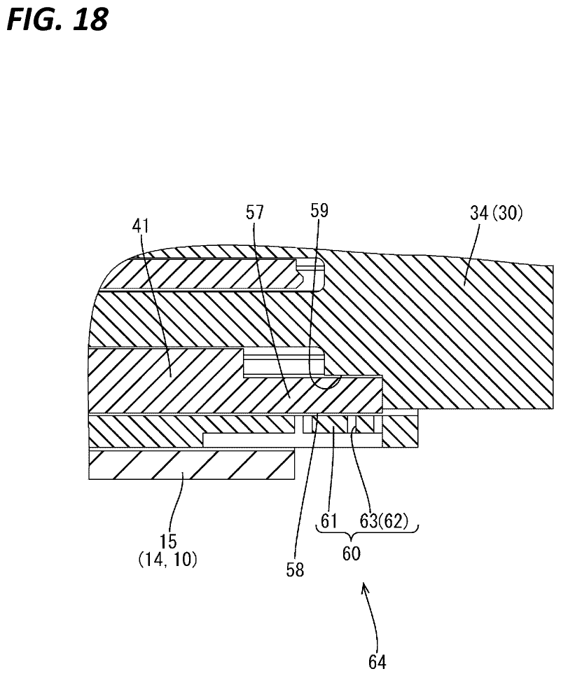

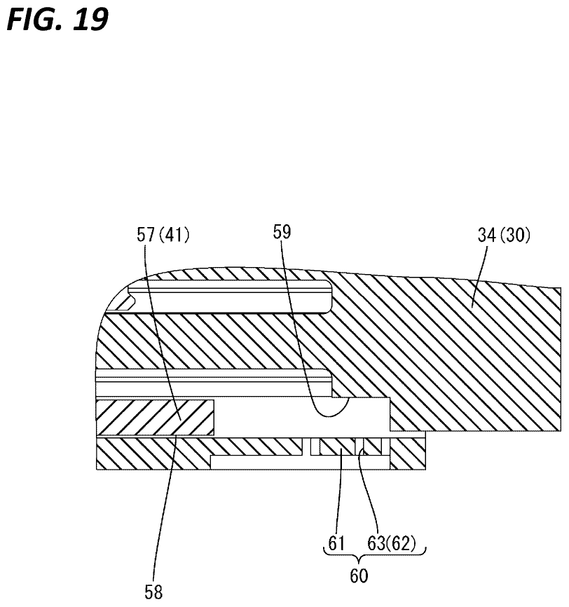

As shown in FIGS. 18 and 19, the female housing 34 includes an accommodation space 59 for receiving the projecting portion 57 of the female retainer 41. The accommodation space 59 is provided on a back side of a left upper part of the inside of the female housing 34. The formwork portion 60 is provided on the left side wall of the female housing 34 located to the left of the accommodation space 59. The formwork portion 60 is recessed rightward from the outer surface of the left side wall of the female housing 34. As shown in FIG. 18, the formwork portion 60 is disposed to the left of the background portion 58 in a state where the connection of the male and female connectors 10, 30 is completed and the female retainer 41 is held at the completion position. As shown in FIGS. 1, 5, 8 and 15, the formwork portion 60 is visually confirmable from outside.

### Body Portion, Recesses and Through Holes

As shown in FIGS. 18 and 19, the formwork portion 60 includes a body portion 61 in the form of a flat plate in the lateral direction and recesses 62 recessed rightward from the body portion 61. In this embodiment, the recess 62 is a through hole 63 penetrating through the body portion 61 in the lateral direction.

### Code

As shown in FIG. 18, with the female retainer 41 including the background portion 58 held at the completion position, the formwork portion 60 and the background portion 58 are disposed to overlap in the lateral direction. At this time, the background portion 58 is exposed to the left side of the female housing 34 through the through holes 63. On the other hand, the body portion 61 is formed to have such a thickness that the color of the background portion 58 cannot be seen through the body portion 61. Accordingly, if the female housing 34 is viewed from left when the female retainer 41 is at the completion position, the body portion 61 and the background portion 58 disposed inside the through holes 63 (recesses 62) can be recognized as shown in FIG. 15. The formwork portion 60 and the background portion 58 have mutually different colors (to be described in detail later). In this way, when the female retainer 41 is at the completion position, the formwork portion 60 and the background portion 58 generate the code 64 detectable from left by a detector such as a camera. Any one of a one-dimensional code, a two-dimensional code and a three-dimensional code may be used as the code 64, but a two-dimensional code is used in the first embodiment.

A color difference between the formwork portion 60 and the background portion 58 described above is specifically a color difference detectable by the detector such as a camera. For example, a color combination having contrast due to a brightness, hue or saturation difference can be adopted as a combination of the colors of the formwork portion 60 and the background portion 58. Further, colors include fluorescent colors. For example, a paint fluorescent when ultraviolet rays are irradiated may be applied to either one of the formwork portion 60 and the background portion 58, and the code 64 may be detected by the detector under ultraviolet irradiation. Note that the female retainer 41 including the background portion 58 is shown by hatching for easy viewing in FIGS. 1 to 5 and 15. In this embodiment, the entire housing 34 has the same color as the formwork portion 60, and the entire female retainer 41 has the same color as the background portion 58.

Information such as “connection completion” and a “lot number” are recorded as the two-dimensional code in the code 64. This code 64 can be read by the detector, and the read information can be recorded in a recording device. For example, by detecting the code 64 and reading the information by the detector after the connection of the female connector 30 and the male connector 10 is completed, the completion of connection of the female connector 30 and the male connector 10 can be recorded in the recording device.

In a state where the female retainer 41 is not disposed at the completion position, the entire formwork portion 60 and the background portion 58 do not overlap in the lateral direction. For example, in a state shown in FIG. 19 where the female retainer 41 is held at the locking position, the background portion 58 is located forward of the formwork portion 60. Thus, when the female retainer 34 is viewed from left, the inside of the female retainer 34 can be recognized via the formwork portion 60 as shown in FIG. 8. The inside of the female housing 34 and the formwork portion 60 have the same color. Thus, when the female retainer 41 is at the locking position, the code 64 detectable by the detector does not appear.

As shown in FIG. 5, with the female retainer 41 held at the retracted position, the female retainer 41 is located forward of the locking position, wherefore the code 64 does not appear as in the above case. Further, although not shown, a part of the formwork portion 60 and the background portion 58 overlap and a part of the code 64 appears, but the information cannot be detected by the detector in a state where the female connector 30 and the male connector 10 are connected halfway and the female retainer 41 is disposed between the locking position (see FIG. 8) and the completion position (see FIG. 15).

As described above, in this embodiment, the position where the code 64 appears on the female housing 34 can be known by the formwork portion 60 constituting the code 64 together with the background portion 58. Since the formwork portion 60 is provided on the female housing 34 to be visually confirmable from outside, the position of the code 64 is easily found in detecting the code 64.

On the other hand, since the code 64 itself appears with the connection of the female connector 30 and the male connector 10 completed, but does not appear without the female retainer 41 being disposed at the completion position, erroneous detection of the code 64 can be suppressed.

### Assembly Process of Connector Assembly

Next, an assembly process of the connector assembly 1 is described. Note that the assembly process of the connector assembly 1 is not limited to the one described below.

The male terminal 11 is inserted into the male cavity 16 of the male housing 14 from behind. By the contact of the male terminal 11 with the male locking lance 17, the male locking lance 17 is resiliently deformed into the resilient deformation space 22. If the male terminal 11 is further pushed forward, the male locking lance 17 is restored, whereby the front end part of the male locking lance 17 comes into contact with the male terminal 11 from behind. In this way, the male terminal 11 is accommodated in the male housing 14 while being prevented from coming out rearward.

The male retainer 20 is inserted into the male cavities 16 from front. By the entrance of the restricting portion 23 of the male retainer 20 into the resilient deformation space 22 for the male locking lances 17, the resilient deformation of the male locking lances 17 is restricted. By the resilient engagement of the lock portions 21 of the male retainer 20 with the male housing 14, the male retainer 20 is assembled with the male housing 14 while being prevented from coming out forward.

The female retainer 41 is inserted into the retainer accommodating portion 38 of the female housing 34 from front. By the contact of the first locking portions 45 of the female retainer 41 and the upper wall of the female housing 34, the upper wall of the female housing 34 is deformed to ride on the first locking portions 45 and the first locking portions 45 are deformed downward. If the female retainer 41 is further pushed rearward, the upper wall of the female housing 34 and the first locking portions 45 are restored and the first locking portions 45 enter the first lock receiving portions 49 of the female housing 34. By the contact of the front end parts of the first locking portions 45 with the front walls of the first lock receiving portions 49 from behind, the female retainer 41 is held in the female housing 34 while being stopped in front (see FIG. 6). Further, by the contact of the rear end parts of the second locking portions 46 with the front end edge of the upper wall of the female housing 34 from front, a rearward movement of the female retainer 41 is restricted (see FIG. 7). In this way, the female retainer 41 is assembled with the female housing 34 at the retracted position.

With the female retainer 41 assembled with the female housing 34 at the retracted position, the restricting portion 42 of the female retainer 41 is located in front of the resilient deformation space 40 of the female housing 34. In this way, the female locking lances 39 of the female housing 34 are resiliently deformable.

The female terminal 31 is inserted into the female cavity 37 of the female housing 34 from behind. By the contact of the female terminal 31 with the female locking lance 39, the female locking lance 39 is resiliently deformed into the resilient deformation space 40. If the female terminal 31 is further pushed forward, the female locking lance 39 is restored, whereby the front end part of the female locking lance 39 comes into contact with the female terminal 31 from behind. In this way, the female terminal 31 is accommodated in the female housing 34 while being prevented from coming out rearward.

By pushing the female retainer 41 rearward, the rear end parts of the second locking portions 46 come into contact with the front end edge of the upper wall of the female housing 34 from front. In this way, the upper wall of the female housing 34 is deformed to ride on the second locking portions 46.

If the female retainer 41 is further pushed rearward, the upper wall of the female housing 34 is restored and the second locking portions 46 enter the second lock receiving portions 50 of the female housing 34. By the contact of the front end parts of the second locking portions 46 with the front walls of the second lock receiving portions 50 from behind, the female retainer 41 is held in the female housing 34 while being stopped in front (see FIG. 10). Further, by the contact of the rear end parts of the third locking portions 48 with the rear wall of the front third lock receiving portion 54 from front, the female retainer 41 is held in the female housing 34 with a rearward movement restricted (see FIG. 11). In this way, the female retainer 41 is assembled with the female housing 34 at the locking position.

With the female retainer 41 assembled with the female housing 34 at the locking position, the restricting portion 42 of the female retainer 41 is located in the resilient deformation space 40 of the female housing 34 as shown in FIG. 9. In this way, the female locking lances 39 of the female housing 34 are prevented from being resiliently deformed. As a result, the female terminals 31 are doubly locked by the female locking lances 39 and the female retainer 41.

Subsequently, the male connector 10 and the female connector 30 are arranged to face each other (see FIG. 1) and connected toward each other.

The front end part of the female connector 30 is fit into the receptacle 15 of the male connector 10. Then, the front end edge of the lower wall of the receptacle 15 comes into contact with the lock portion 36 of the lock arm 35 of the female housing 34 from front. In this way, as shown in FIG. 14, the lock arm 35 is resiliently deformed upward. If the male connector 10 is further pushed forward, the lock arm 35 is restored and the lock portion 36 enters the lock receiving portion 18 of the receptacle 15 of the male connector 10 as shown in FIG. 17. In this way, the male connector 10 and the female connector 30 are held retained.

If the female connector 30 is fit into the receptacle 15 of the male connector 10, the pressing projection 19 of the receptacle 15 comes into contact with the projection 53 of the resilient deforming portion 52 of the female housing 34 from front. Then, as shown in FIG. 14, the resilient deforming portion 52 is resiliently deformed downward. If the resilient deforming portion 52 is resiliently deformed downward, the arm portions 47 of the female retainer 41 located below the resilient deforming portion 52 are resiliently deformed downward. Then, the third locking portions 48 of the arm portions 47 move downward, and the third locking portions 48 and the rear wall of the front third lock receiving portion 54 are disengaged.

If the male connector 10 is further pushed forward, the front end part of the contact portion 24 of the male retainer 20 comes into contact with the front end part of the female retainer 41 from front. In this way, the female retainer 41 moves rearward.

If the male connector 10 is further pushed forward, the resilient deforming portion 52 of the female housing 34 is restored and the projection 53 of the resilient deforming portion 52 is located in front of the pressing projection 19 of the receptacle 15 as shown in FIG. 17. Then, the arm portions 47 of the female retainer 41 located below the resilient deforming portion 52 are also restored, and the third locking portions 48 of the arm portions 47 enter the rear third lock receiving portions 55. In this way, the rear end parts of the third locking portions 48 come into contact with the rear walls of the rear third lock receiving portions 55 from front and a rearward movement of the female retainer 41 is restricted. In this way, the female retainer 41 is assembled with the female housing 34 at the completion position.

On the other hand, if the female connector 30 is fit into the receptacle 15 of the male connector 10, the front end parts of the arm portions 25 of the male retainer 20 come into contact with the front end edge of the female retainer 41. Then, the arm portions 25 are resiliently deformed to ride on the upper wall of the female retainer 41. If the male connector 10 is further pushed forward, the arm portions 25 are restored and the locking portions 26 of the arm portions 25 enter the locking recesses 43 of the female retainer 41 (see FIG. 12).

### Separation Process of Connector Assembly

Next, a separation process of the male connector 10 and the female connector 30 is described. By resiliently deforming the lock arm 35 upward, the lock portion 36 of the female connector 30 and the lock receiving portion 18 of the male connector 10 are disengaged. Thereafter, pulling forces are applied to the male connector 10 and the female connector 30 to separate the male connector 10 and the female connector 30 from each other.

Then, as shown in FIG. 12, the locking portions 26 of the arm portions 25 of the male retainer 20 come into contact with the lock receiving portions 44 of the locking recesses 43 of the female retainer 41 from behind. In this way, a forward force is applied to the female retainer 41.

If the female retainer 41 is pulled forward via the locking portions 26 by the male retainer 20, the arm portions 47 of the female retainer 41 are resiliently deformed to slip under the upper wall of the female housing 34. In this way, the third locking portions 48 of the female retainer 41 and the rear third lock receiving portions 55 of the female housing 34 are disengaged (see FIG. 14).

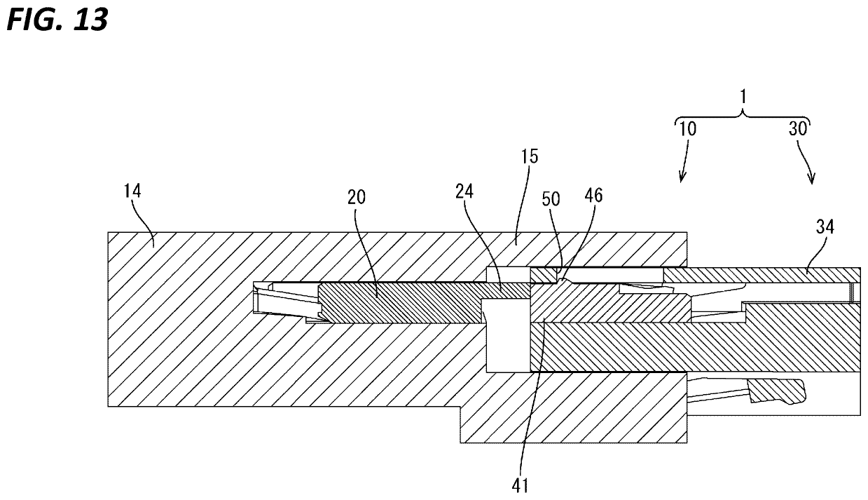

If the female retainer 41 is further pulled forward, the front end parts of the second locking portions 46 of the female retainer 41 come into contact with the front walls of the second lock receiving portions 50 from behind (see FIG. 13). Then, since a holding force between the second locking portions 46 of the female retainer 41 and the second lock receiving portions 50 of the female housing 34 is set larger than a holding force between the locking portions 26 of the male retainer 20 and the lock receiving portions 44 of the female retainer 41, the locking portions 26 of the male retainer 20 and the lock receiving portions 44 of the female retainer 41 are disengaged. Further, the arm portions 47 of the female retainer 41 are restored, whereby the third locking portions 48 enter the front third lock receiving portion 54 (see FIG. 11). In this way, the female retainer 41 moves to the locking position with respect to the female housing 34 and is held at the locking position.

Further, by applying pulling forces to the male connector 10 and the female connector 30 to separate the male connector 10 and the female connector 30 from each other, the connection of the male connector 10 and the female connector 30 is released (see FIG. 1).

### Visual Confirmation and Detection of Code

In the connection process and the separation process of the male connector 10 and the female connector 30 described above, the formwork portion 60 is constantly visually confirmable from the left of the female connector 30. Thus, the appearance position of the code 64 is easily found.

Further, in the connection process and the separation process of the male connector 10 and the female connector 30 described above, the female retainer 41 is disposed at the completion position only with the connection of the male connector 10 and the female connector 30 completed. Thus, the completion of connection of the male connector 10 and the female connector 30 can be detected by the code 64 appearing when the female retainer 41 is at the completion position.

### Functions and Effects of Embodiment

According to the first embodiment, the following functions and effects are achieved.

The female connector 30 (connector) according to the first embodiment is connected to the male connector 10 (mating connector) and provided with the female terminals 31 (terminal), the female housing 34 (housing) for accommodating the female terminals 31 inside and the formwork portion 60 provided on the female housing 34 to be visually confirmable from outside. The formwork portion 60 includes the body portion 61 and the recesses 62 recessed from the body portion 61 in the intersecting direction intersecting the connection direction of the female connector 30 and the male connector 10. The female connector 30 is provided with the background portion 58 disposed more inward than the formwork portion 60 in the female housing 34. With the connection of the female connector 30 and the male connector 10 completed, the background portion 58 is disposed at the completion position and the formwork portion 60 and the background portion 50 overlap in the intersecting direction, whereby a color difference is produced between the inner parts of the recesses 62 and the body portion 61 to make the code 64 detectable from outside appear. The code 64 does not appear without the background portion 58 being disposed at the completion position.

According to this configuration, since the formwork portion 60 of the female connector 30 is provided to be visually confirmable from outside and the code 64 detectable from outside appears by the formwork portion 60 and the background portion 58 overlapping with the connection of the female connector 30 and the male connector 10 completed, a worker can recognize the appearance position of the code 64 by the formwork portion 60 before connecting the female connector 30 and the male connector 10.

The female connector 30 according to the first embodiment is further provided with the female retainer 41 (retainer) for retaining the female terminals 31 in the female housing 34, and the female retainer 41 includes the background portion 58.

According to this configuration, the code 64 can be made to appear by the formwork portion 60 of the female housing 34 and the background portion 58 of the female retainer 41.

In the first embodiment, the recesses 62 are the through holes 63 penetrating through the body portion 61.

According to this configuration, since the background portion 58 is exposed to outside via the through holes 63, a color difference is easily produced between the background portion 58 and the body portion 61.

### Second Embodiment

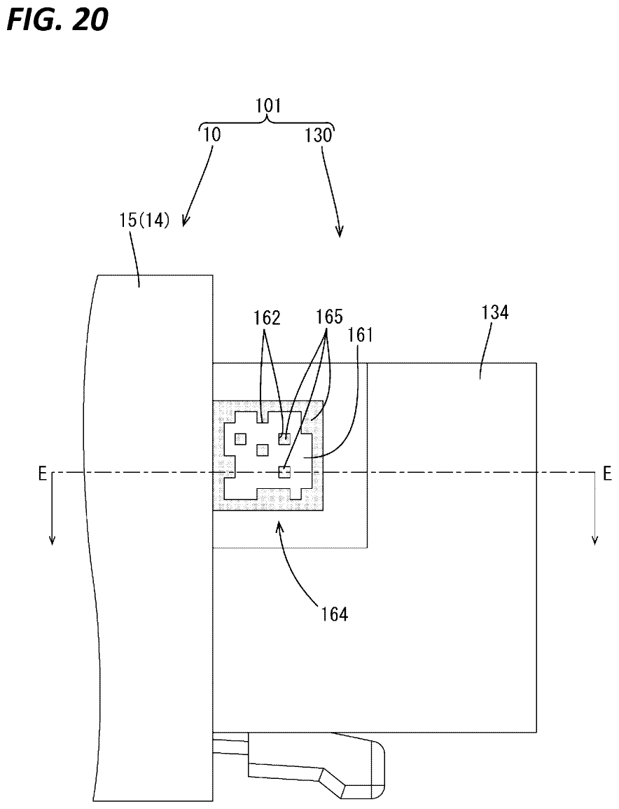

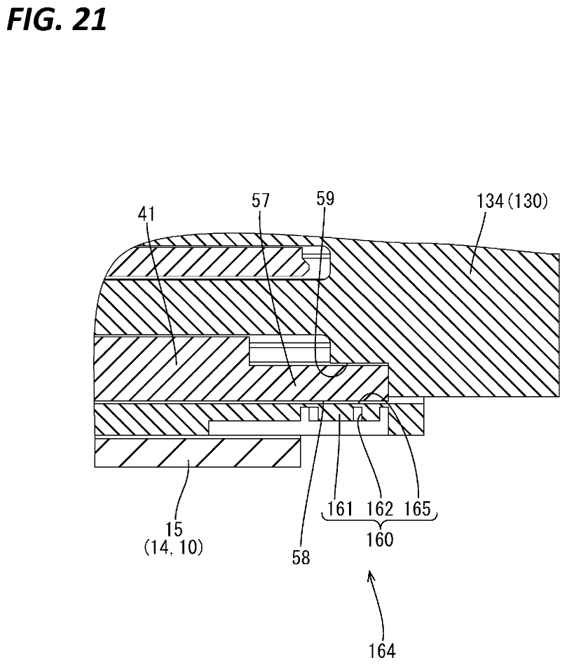

A second embodiment of the present disclosure is described with reference to FIGS. 20 and 21. A connector assembly 101 according to the second embodiment includes a female connector 130 and a male connector 10 as shown in FIG. 20. The second embodiment differs from the first embodiment in that thin portions 165 are provided in recesses 162 of a formwork portion 160 as shown in FIG. 21. For the other configuration, components similar to those of the first embodiment are denoted by the same reference signs and not described. Functions and effects similar to those of the first embodiment are also not described.

### Thin Portions

As shown in FIG. 21, a female housing 134 of the female connector 130 is provided with the formwork portion 160. The formwork portion 160 of the female housing 134 is arranged similarly to the formwork portion 60 of the first embodiment. The formwork portion 160 includes a body portion 161 and the recesses 162 recessed rightward from the body portion 161. The recesses 62 of the first embodiment are formed to penetrate through the body portion 61, whereas the recesses 162 of this embodiment are not formed to penetrate through the body portion 161. That is, the recesses 162 are provided with the thin portions 165 thinner in the lateral direction than the body portion 161. By forming the recesses 162, which are not through holes, in this way, the recesses 162 are easily formed.

The thin portions 165 are formed to have such a thickness that the color of a member disposed on a back side across the thin portions 165 is seen through when viewed from the lateral direction. In this way, the color of the background portion 58 is seen through the thin portions 165 as shown in FIG. 20 in a state where a female retainer 41 is held at a completion position and the formwork portion 160 and a background portion 58 overlap in the lateral direction, whereby a color difference is produced between inner parts (thin portions 165) of the recesses 162 and the body portion 161 when the formwork portion 160 is viewed from left. A code 164 detectable by a detector appears due to this color difference.

Further, by providing the thin portions 165 in the recesses 162, the left side wall of the female housing 134 and the body portion 161 can be connected via the thin portions 165. Thus, the body portion 161 needs not be directly connected to the left side wall of the female housing 134. Accordingly, the body portion 161 can be formed into an island shape with respect to the left side wall of the female housing 134 without being connected to the left side wall of the female housing 134. On the other hand, since the recesses 62 are the through holes 63 in the first embodiment as shown in FIG. 15, the body portion 61 need to be directly connected to the left side wall of the female housing 134. As just described, in the second embodiment, a degree of freedom in designing the code 164 can be improved as compared to the first embodiment by forming the recesses 162 to include the thin portions 165.

### Functions and Effects of Second Embodiment

According to the second embodiment, the following function and effect are achieved.

In the second embodiment, the recesses 162 are provided with the thin portions 165 thinner than the body portion 161.

According to this configuration, the recesses 162 are easily formed.

### Other Embodiments

(1) Although the female retainer 41 of the female connector 30, 130 is provided with the background portion 58 in the above embodiments, there is no limitation to this. For example, a female connector may be provided with a moving plate and this moving plate may be provided with a background portion. Further, a male retainer or a receptacle of a male connector may be provided with a background portion.

(2) Although the entire female housing 34, 134 has the same color as the formwork portion 60, 160 and the entire female retainer 41 has the same color as the background portion 58 in the above embodiments, there is no limitation to this. Only a part of a female housing may have the same color as a formwork portion or only a part of a female retainer may have the same color as a background portion.

(3) Unlike the above embodiments, a background portion may be a light source, and a code may be made to appear by producing a color difference between inner parts of recesses and a body portion with the background portion and the body portion overlapping.

(4) Although the recesses 62 are the through holes 63 in the first embodiment and the recesses 162 are provided with the thin portions 165 in the second embodiment, there is no limitation to this. A formwork portion may include both recesses in the form of through holes and recesses provided with thin portions.

(5) Although the male connector 10 includes the male retainer 20 including the contact portion 24 in the above embodiments, there is no limitation to this. A male housing may be provided with a contact portion, and a male retainer may be omitted.

### List of Reference Numerals

1, 101: connector assembly
10: male connector
11: male terminal
12: tab
13: wire connecting portion
14: male housing
15: receptacle
16: male cavity
17: male locking lance
18: lock receiving portion
19: pressing projection
20: male retainer
21: lock portion
22: resilient deformation space
23: restricting portion
24: contact portion
25: arm portion
26: locking portion
30, 130: female connector
31: female terminal
32: connecting tube portion
33: wire connecting portion
34, 134: female housing
35: lock arm
36: lock portion
37: female cavity
38: retainer accommodating portion
39: female locking lance
40: resilient deformation space
41: female retainer
42: restricting portion
43: locking recess
44: lock receiving portion
45: first locking portion
46: second locking portion
47: arm portion
48: third locking portion
49: first lock receiving portion
50: second lock receiving portion
51: slit
52: resilient deforming portion
53: projection
54: front third lock receiving portion
55: rear third lock receiving portion
57: projecting portion
58: background portion
59: accommodation space
60, 160: formwork portion
61, 161: body portion
62, 162: recess
63: through hole
64, 164: code
165: thin portion
W1: wire
W2: wire

1. A connector to be connected to a mating connector, comprising
a terminal;
a housing for accommodating the terminal inside;
a formwork portion provided on the housing to be visually confirmable from outside; and
a retainer to be assembled with the housing movably between a retracted position where the terminal is insertable into the housing, a locking position where the terminal is retained inside the housing and a completion position,
the retainer moving from the locking position to the completion position by connecting the connector and the mating connector,
the formwork portion including a body portion and recesses recessed from the body portion in an intersecting direction intersecting a connection direction of the connector and the mating connector,
the retainer including a background portion to be disposed more inward than the formwork portion in the housing,
the formwork portion and the background portion overlapping in the intersecting direction, whereby a color difference is produced between inner parts of the recesses and the body portion to make a code detectable from outside appear, with the retainer disposed at the completion position, and
the code not appearing without the retainer being disposed at the completion position.

2. (canceled)

3. The connector of claim 1, wherein the recesses are through holes penetrating through the body portion.

4. The connector of claim 1, wherein thin portions thinner than the body portion are provided in the recesses.
